(19) United States
(12) Patent Application Publication
(10) Pub. No.: US 2014/0255000 A1
(43) Pub. Date: Sep. 11, 2014

(54) VIDEO PLAYBACK SYSTEM AND METHOD BASED ON HIGHLIGHT INFORMATION

(71) Applicant: National Taiwan University, Taipei (TW)

(72) Inventors: Chen-Tai Kao, Taipei (TW); Homer H. CHEN, Taipei (TW)

(21) Appl. No.: 13/932,989

(22) Filed: Jul. 1, 2013

(30) Foreign Application Priority Data
Mar. 8, 2013 (TW) 102108381

(51) Int. Cl. G11B 27/00; H04N 9/87

(52) U.S. Cl. CPC G11B 27/002; H04N 9/87; G11B 27/005
USPC 386/230; 386/262

(57) ABSTRACT

A video playback system and method based on highlight information are disclosed. The video playback system includes a user interface, an extracting unit, a determining unit, an adjusting unit and a playback unit. The user interface is configured to receive a control command, including a highlight mode command. The extracting unit is configured to extract highlight information from an input video, according to the highlight mode command. The determining unit is configured to determine at least one highlight video clip. The adjusting unit is configured to provide an adjusting playback velocity. The playback unit is configured to play the input video at the adjusting playback velocity according to the highlight mode command.

### CROSS-REFERENCE TO RELATED APPLICATIONS

The entire contents of Taiwan Patent Application No. 102108381, filed on Mar. 8, 2013, from which this application claims priority, are incorporated herein by reference.

### BACKGROUND OF THE INVENTION

1. Field of the Invention

The present invention generally relates to a video playback system and a method thereof. More particularly, the present invention relates to a video playback system based on highlight information and a method thereof.

2. Description of Related Art

As for the conventional media player, the user must watch the whole content of the video so as to get the exciting highlight part of the video. However, it would take the user too much time to watch the boring parts of the video. Even though highlight parts of the video are extracted to form a compact highlight clip, the user may also want to watch the non-highlight clips, but the non-highlight clips are not existed in the compact clips at all. Furthermore, as the compact highlight clip usually is extracted and formed by the video provider with subjective criteria, therefore some key highlight video clips would be missed, such that it may probably reduce the attractiveness of the video and the user's willingness to watch the whole video.

Accordingly, a need continues to exist for a system and method for efficiently playing the input video based on the highlight information according to the user's preference or need.

### SUMMARY OF THE INVENTION

In view of the foregoing, it is an object of embodiments of the present invention to provide a video playback system based on highlight information. The video playback system includes a user interface, an extracting unit, a determining unit, an adjusting unit and a playback unit. The user interface is configured to receive a control command, and the control command includes a highlight mode command. The extracting unit is configured to extract highlight information from an input video according to the highlight mode command. The determining unit is configured to determine at least one highlight video clip of the input video according to the highlight information. The adjusting unit is configured to provide an adjusting playback velocity for the input video according to the highlight video clip. The playback unit is configured to play the input video, wherein when the highlight mode command is received, the input video is played at the adjusting playback velocity.

Another aspect of the present invention is to provide a video playback method based on highlight information, including the following steps: firstly, receiving a control command, which includes a highlight mode command; then, extracting highlight information from an input video according to the highlight mode command; furthermore, determining at least one highlight video clip of the input video according to the highlight information; consequently, providing an adjusting playback velocity for the input video according to highlight video clip; and, playing the input video, wherein when the highlight mode command is received, the input video is played at the adjusting playback velocity.

### BRIEF DESCRIPTION OF THE DRAWINGS

FIG. 1 shows a block diagram of the video playback system based on highlight information according to an embodiment of the invention;

FIG. 2 shows a flow diagram of the video playback method based on highlight information according to an embodiment of the invention; and

FIG. 3 shows a flow diagram of the video playback method based on highlight information according to another embodiment of the invention.

### DETAILED DESCRIPTION OF THE PREFERRED EMBODIMENT

The detailed description of the present invention will be discussed in the following embodiments, which are not intended to limit the scope of the present invention, and can be adapted for other applications. While drawings are illustrated in detail, it is appreciated that the quantity of the disclosed components may be greater or less than that disclosed, except where expressly restricting the amount of the components.

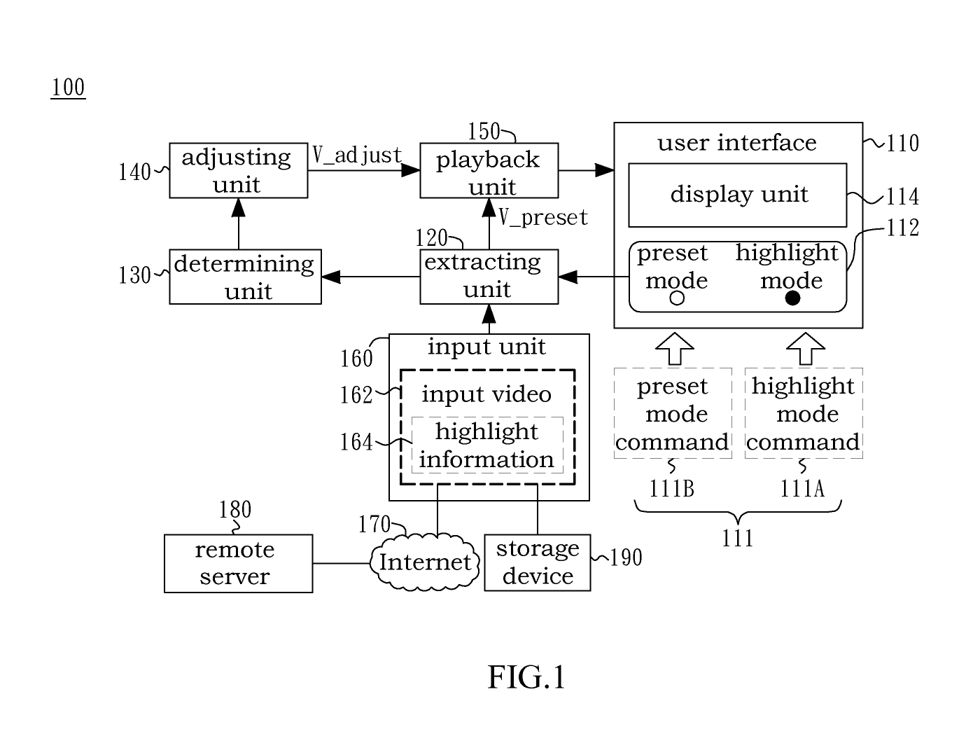

Referring to FIG. 1, FIG. 1 shows a block diagram of the video playback system based on highlight information according to an embodiment of the invention. As shown in FIG. 1, a video playback system 100 includes a user interface 110, an extracting unit 120, a determining unit 130, an adjusting unit 140 and a playback unit 150.

The user interface 110 is configured to receive a control command 111 from a user. The control command 111 includes a highlight mode command 111A. The extracting unit 120 is configured to extract highlight information 164 from an input video 162 according to the highlight mode command 111A. The determining unit 130 is configured to determine at least one highlight video clip of the input video 162 according to the highlight information 164. The adjusting unit 140 is configured to provide an adjusting playback velocity (V_adjust) for the input video 162 according to the highlight video clip. The playback unit 150 is configured to play the input video 162. When the user interface 110 receives the highlight mode command 111A, the playback unit 150 plays the input video 162 at the adjusting playback velocity (V_adjust). In an embodiment, the extracting unit 120 may extract the highlight information 164 from a header of the input video 162. However, the present invention is not limited to the application of this embodiment. For example, the highlight information and the preset playback velocity (V_preset) may also be provided from other external information or be preset directly by the user.

Moreover, the extracting unit 120 may also extract a preset playback velocity (V_preset) from the input video according to the highlight mode command 111A, such that the adjusting unit 140 may appropriately provide an adjusting playback velocity (V_adjust) in accordance with the highlight video clip and the preset playback velocity (V_preset). For example, in an embodiment, when the playback unit 150 plays the highlight video clip, the adjusting playback velocity (V_adjust) may be adjusted to be the same as or less than the preset playback velocity (V_preset). More particularly, when the key highlight video clip is being played, the adjusting playback velocity (V_adjust) may correspondingly remain the same as the preset playback velocity (V_preset); or, the adjusting playback velocity (V_adjust) may be adjusted will be 0.8 or 0.5 times as fast as the preset playback velocity (V_preset). Consequently, as the highlight video clip is played at the slow playback velocity, the user may watch all the highlight video clips and the content in detail.

The determining unit 130 can determine at least one non-highlight video clip of the input video 162 according to the highlight information. Then, the adjusting unit 140 may provide an adjusting playback velocity (V_adjust) in accordance with the non-highlight video clip and the preset playback velocity (V_preset), such that when the playback unit 150 plays the non-highlight video clip, the adjusting playback velocity (V_adjust) may be greater than the preset playback velocity (V_preset). That is to say, when the non-highlight video clip is played, the adjusting playback velocity (V_adjust) will be increased. For example, the adjusting playback velocity (V_adjust) will be adjusted to be 2 or 4 times faster than the preset playback velocity (V_preset). As the non-highlight video clip is played at the high playback velocity, it may efficiently save the user's time without missing any video clip and content.

Consequently, the user may input the highlight mode command 111A to the user interface 110, so that the value of the playback velocity of each clips of input video 162 may be inversely proportional to the exciting or brilliant degree of the highlight content of each clip. Therefore, the user may save lots of time to watch the whole highlight video clips without missing any other clips by selecting the highlight mode to play the video.

However, in one embodiment, the user interface 110 may further be configured to receive a control parameter. The control parameter may decide the proportion for playing the non-highlight video clip, and the control parameter may be between 0 and 1. Therefore, the user can watch all of the highlight video clips, and the user may simultaneously adjust the proportion for playing the non-highlight video clip according to the preference by inputting the control parameter to the user interface 110. More specifically, when the control parameter, which the user interface 110 receives, is “0”, the playback unit 150 will skip all of the non-highlight video clips and only play the highlight video clip. On the other hand, when the control parameter is “1”, the playback unit 150 will play all of the non-highlight video clips and also play all of the highlight video clips. Therefore, when the control parameter is “0.3”, the playback unit 150 will correspondingly play thirty percent of the non-highlight video clip and play all of the highlight video clips as well.

Moreover, the control command 111 further includes a preset mode command 111B. When the user interface 120 receives the preset mode command 111B, the extracting unit 120 may correspondingly extract the preset playback velocity (V_preset). Then, the playback unit 150 may play the input video 162 at the preset playback velocity (V_preset). Therefore, the user may watch the input video 162 at the preset playback velocity (V_preset) by inputting the preset mode command 111B to the user interface 110.

Furthermore, in one embodiment, the user interface 110 includes a toggle button 112 for switching the highlight mode command 111A or the preset mode command 111B. As a result, the user may immediately switch the video playing mode according to the preference or the need, so as to enhance the user's watching experience.

In addition, the video playback system 100 further includes an input unit 160. The input unit 160 may input the input video 162 from a local site or a remote site to the video playback system 100 through the Internet according to the user's control command. More particularly, as shown in FIG. 1, when the input unit 160 receives the user's control command, the input unit 160 may transmit the input video 162 to the video playback system 100 from a remote server 180 through the Internet 170, or the input unit 160 may extract the input video 162 from the storage device 190 of the local site. However, in another embodiment, the user interface 110 further includes a display unit 114, which is configured to display the input video 162.

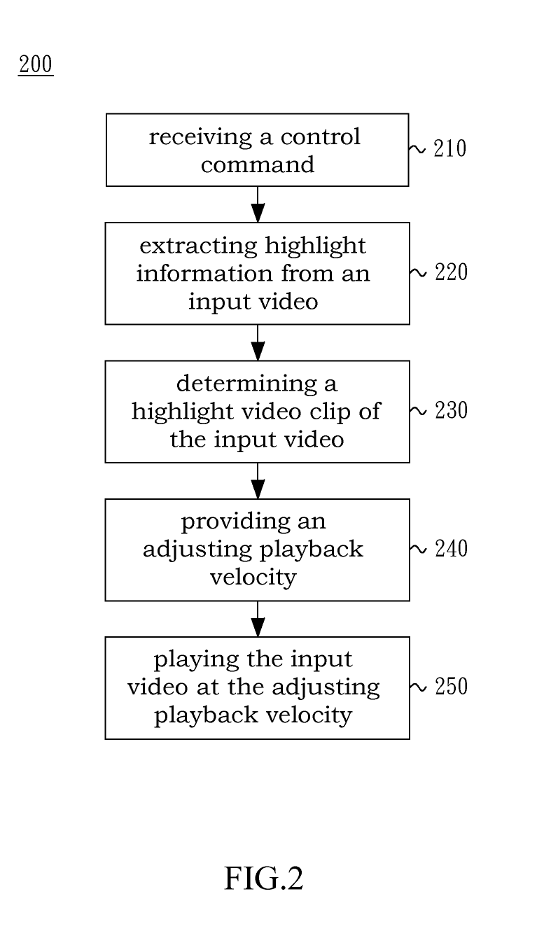

Referring to FIG. 2, FIG. 2 shows a flow diagram for a video playback method 200 based on highlight information according to an embodiment of the present invention. As shown in FIG. 2, the video playback method 200, which may be applied to the video playback system 100 described above, includes the following steps. In step 210, a user interface receives a control command, and the control command includes a highlight mode command.

In step 220, the highlight information is extracted from the input video according to the highlight mode command, and a preset playback velocity (V_preset) may also be extracted simultaneously. The input video may be transmitted from a local site or a remote server through the Internet according to the user's control command. Furthermore, in one embodiment, the highlight information and the preset playback velocity (V_preset) may be extracted from a header of the input video. However, the present invention is not limited to the application of this embodiment. For example, the highlight information and the preset playback velocity (V_preset) may also be provided from other external information or be preset directly by the user.

Then, in step 230, the highlight video clip of the input video is determined according to the highlight information. On the contrary, the non-highlight video clip of the input video may also be determined according to the highlight information.

In step 240, an adjusting playback velocity (V_adjust) may be provided for the input video according to the highlight video clip and the preset playback velocity (V_preset). When the highlight video clip is played, the adjusting playback velocity (V_adjust) will be correspondingly adjusted to be the same as or less than the preset playback velocity (V_preset). On the other hand, when the non-highlight video clip is played, the adjusting playback velocity (V_adjust) may correspondingly be adjusted to be greater than the preset playback velocity (V_preset). Consequently, the non-highlight video clip can be played at a high playback velocity, so as to save the user's times. However, when the highlight video clip is being played, the corresponding playback velocity may be switched to be the normal preset playback velocity or a slow playback velocity. Therefore, the user may efficiently and quickly watch the highlight video clip without missing any video clips.

In step 250, the input video is played according to the control command. More particularly, when the highlight mode command is received, the input video is played at the adjusting playback velocity. Furthermore, in one embodiment, the input video may be displayed on the user interface.

However, in one embodiment, the method 200 may further include the step of the user interface receiving a control parameter. The control parameter may decide the proportion for playing the non-highlight video clip, and the control parameter may be between 0 and 1. Consequently, all of the highlight video clips not only can be played, but the proportion for playing the non-highlight video clip may also be adjusted according to user's preference by the control parameter. More specifically, when the control parameter, which the user interface receives, is “0”, all of the non-highlight video clips will be skipped and only the highlight video clip will be played. On the other hand, when the control parameter is “1”, all of the non-highlight video clips and the highlight video clips will be played. Therefore, when the control parameter is “0.3”, the thirty percent of the non-highlight video clips and all of the highlight video clips will correspondingly be played.

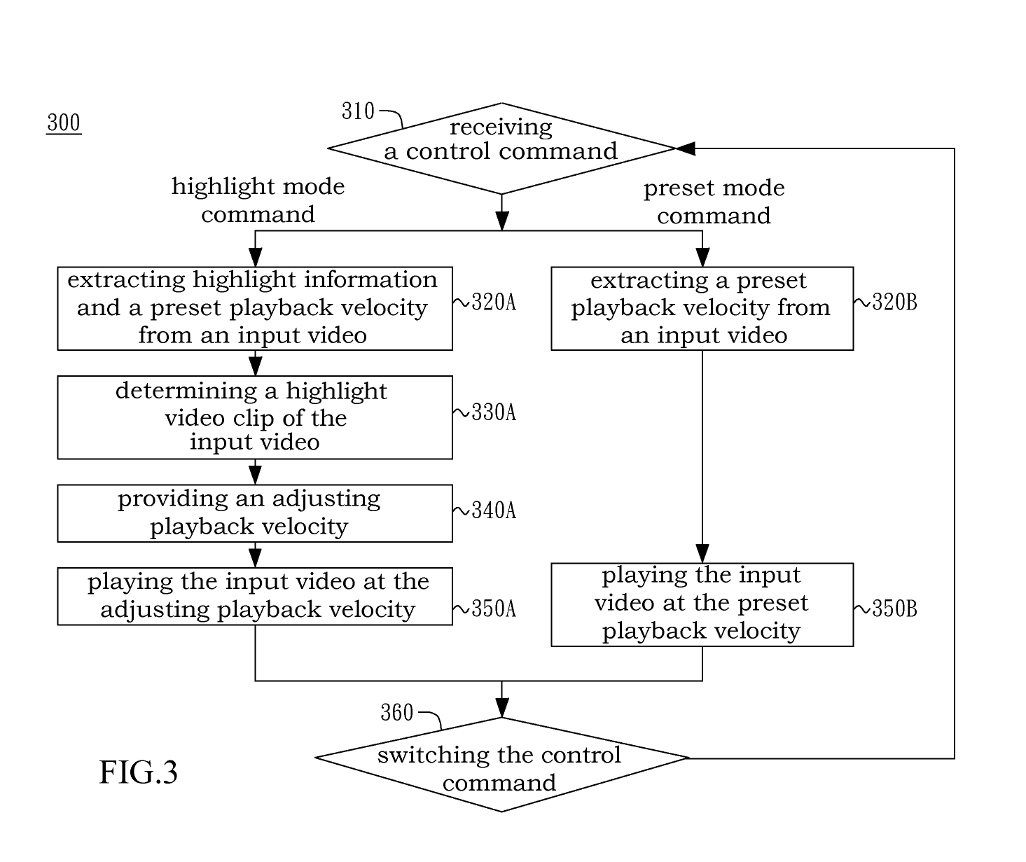

Referring to FIG. 3, FIG. 3 shows a flow diagram for a video playback method 300 based on highlight information according to another embodiment of present invention. As shown in FIG. 3, in step 310, the user interface may receive the control command, and the control command includes a highlight mode command and a preset mode command. However, in step 310, if the user interface receives the highlight mode command, the steps 320A-350A will proceed. As the steps 320A-350A are the same as the steps 220-250 in above embodiment, the details will not be repeated.

However, in step 310, if the user interface receives the preset mode command, then the steps 320B and 350B will proceed. In step 320B, the preset playback velocity (V_preset) will be extracted from the input video according to the preset mode command; and then, in step 350B, the input video will be played at the preset playback velocity.

Moreover, the method 300 further includes step 360. In step 360, the highlight mode command and the preset mode command may be switched for selecting the most appropriate video playing mode for the user immediately.

As a result, according to the video playback system and method based on highlight information illustrated in above embodiments, the user may quickly and completely watch the highlight video clips and contents of the input video without missing the other clips. Furthermore, it may also provide the user to switch for selecting the most appropriate video playing mode immediately according to the user's preference or the need.

Although specific embodiments have been illustrated and described, it will be appreciated by those skilled in the art that various modifications may be made without departing from the scope of the present invention, which is intended to be limited solely by the appended claims.

What is claimed is:

1. A video playback system based on highlight information, comprising:
a user interface configured to receive a control command, wherein the control command comprises a highlight mode command;
an extracting unit configured to extract highlight information from an input video according to the highlight mode command;
a determining unit configured to determine at least one highlight video clip of the input video according to the highlight information;
an adjusting unit configured to provide an adjusting playback velocity for the input video according to the highlight video clip; and
a playback unit configured to play the input video, wherein when the highlight mode command is received, the input video is played at the adjusting playback velocity.

2. The video playback system based on highlight information of claim 1, wherein the extracting unit extracts a preset playback velocity according to the highlight mode command.

3. The video playback system based on highlight information of claim 2, wherein when the playback unit plays the highlight video clip, the adjusting playback velocity is the same as or less than the preset playback velocity.

4. The video playback system based on highlight information of claim 2, wherein the determining unit further determines at least one non-highlight video clip of the input video.

5. The video playback system based on highlight information of claim 4, wherein when the playback unit plays the non-highlight video clip, the adjusting playback velocity is the same as or greater than the preset playback velocity.

6. The video playback system based on highlight information of claim 4, wherein the user interface is further configured to receive a control parameter, and the control parameter determines a proportion for playing the non-highlight video clips, and the control parameter is between 0 and 1, wherein when the control parameter is 0, the playback unit plays none of the non-highlight video clips, and when the control parameter is 1, the playback unit plays all of the non-highlight video clips.

7. The video playback system based on highlight information of claim 1, wherein the control command further comprises a preset mode command.

8. The video playback system based on highlight information of claim 7, wherein the extracting unit extracts a preset playback velocity from the input video according to the preset mode command.

9. The video playback system based on highlight information of claim 8, wherein when the preset mode command is received, the playback unit plays the input video at the preset playback velocity.

10. The video playback system based on highlight information of claim 7, wherein the user interface comprises a toggle button configured to switch the highlight mode command or the preset mode command.

11. The video playback system based on highlight information of claim 1, wherein the extracting unit extracts the highlight information from a header of the input video.

12. The video playback system based on highlight information of claim 1, further comprising an input unit, wherein the input unit inputs the input video from a local site or a remote site through the Internet.

13. The video playback system based on highlight information of claim 1, wherein the user interface further comprises a display unit configured to display the input video.

14. A video playback method based on highlight information, comprising:
receiving a control command, wherein the control command comprises a highlight mode command;
extracting highlight information from an input video according to the highlight mode command;
determining a highlight video clip of the input video according to the highlight information;
providing an adjusting playback velocity of the input video according to the highlight video clip; and
playing the input video, wherein when the highlight mode command is received, the input video is played at the adjusting playback velocity.

15. The video playback method based on highlight information of claim 14, further comprising extracting a preset playback velocity from the input video according to the highlight mode command.

16. The video playback method based on highlight information of claim 15, wherein when the highlight video clip is played, the adjusting playback velocity is the same as or less than the preset playback velocity.

17. The video playback method based on highlight information of claim 15, further comprising determining at least one non-highlight video clip of the input video.

18. The video playback method based on highlight information of claim 17, wherein the non-highlight video clip is played, the adjusting playback velocity is greater than the preset playback velocity.

19. The video playback system based on highlight information of claim 17, further comprising inputting a control parameter, and the control parameter determines a proportion for playing the non-highlight video clips, and the control parameter is between 0 and 1, wherein when the control parameter is 0, none of the non-highlight video clips is played, and when the control parameter is 1, all of the non-highlight video clips are played.

20. The video playback method based on highlight information of claim 14, wherein the control command further comprises a preset mode command.

21. The video playback method based on highlight information of claim 20, further comprising extracting a preset playback velocity from the input video according to the preset mode command.

22. The video playback method based on highlight information of claim 21, wherein when the preset mode command is received, the playback unit plays the input video at the preset playback velocity.

23. The video playback method based on highlight information of claim 20, further comprising switching the highlight mode command or the preset mode command.

24. The video playback method based on highlight information of claim 14, in the step of extracting the highlight information from the input video, further comprising:
extracting the highlight information from a header of the input video.

25. The video playback method based on highlight information of claim 14, further comprising inputting the input video from a local site or the remote site through the Internet.

26. The video playback method based on highlight information of claim 14, further comprising displaying the input video.
